(19) United States
(12) Patent Application Publication
(10) Pub. No.: US 2004/0021890 A1
(43) Pub. Date: Feb. 5, 2004

(54) Image forming apparatus, information processing apparatus and the authentication method

(76) Inventors: Takumi Hirai, Fukuoka (JP); Kunihiro Akiyoshi, Fukuoka (JP); Kazumi Fujisaki, Fukuoka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/394,163

(22) Filed: Mar. 24, 2003

(30) Foreign Application Priority Data
Mar. 25, 2002 (JP) 2002-082241
Jan. 23, 2003 (JP) 2003-015340
Jan. 23, 2003 (JP) 2003-015341

(51) Int. Cl. G06F 11/30; G06F 15/00; G06F 3/00; H04L 9/32

(52) U.S. Cl. 358/1.13; 713/201; 358/1.14; 358/1.15; 710/15

(57) ABSTRACT

An image forming apparatus including hardware resources used for image forming processes and applications for performing image forming processes is provided, in which the image forming apparatus includes: an authentication part for referring to predetermined information and performing authentication of a user who uses an application by using a method according to the predetermined information.

### BACKGROUND OF THE INVENTION

1. Field of the Invention

The present invention relates to user authentication for image forming apparatuses and information processing apparatuses.

2. Description of the Related Art

Recently, an information processing apparatus that includes or connects various hardware resources and that provides user services by using the hardware resources becomes widespread. For example, as an example of the information processing apparatus, an image forming apparatus (to be referred to as a compound machine hereinafter) that includes functions of a printer, a copier, a facsimile, a scanner and the like in a cabinet is generally known.

As for the conventional compound machine, when the compound machine is used by a user, a user authentication process is performed by using an ID (user identification) of the user, so that security is ensured. As an example of an authentication method, an ID registered in the compound machine is compared with an ID input by a user or an ID read from a card (IC card and the like) inserted into a card reading device. An authentication server connected to a network can be also used. In addition, there is a method for restricting use of an application, in which available applications are registered in the compound machine for each user so that the user can use only the registered application. In addition, there is a method in which a key counter or a coin lack is used for allowing a predetermined number of copies.

As mentioned above, various methods have been proposed as the authentication method and the use restriction method. It is desired to provide an authentication method and a use restriction method according to a user's demand quickly. However, according to the conventional technologies, a complicated program needs to be developed for realizing the authentication method or the use restriction method required by the user, or for realizing combination of them required by the user. Thus, it is difficult to meet the demand of the user quickly.

An authentication result can be sent to a management server on a network, so that the server collectively manages invalid accesses to the compound machine. In this case, in the side of the compound machine, it is necessary to generate data of the authentication result appropriate for hardware and software of the management server. In addition, it is necessary to send the data by using a sending method applicable for a network protocol between the compound machine and the management server.

There is a case in which data that is generated by a compound machine is used by a plurality of compound machines, PCs and a management server for various purposes. In this case, every compound machine does not necessarily include the same OS or the same application. Thus, it is necessary to generate the authentication result data to be transmitted and received by using a format applicable to the hardware of the software of the destination compound machine or the management server. In addition, it is necessary to send the data by using a network protocol between the destination and the source compound machine. Therefore, the conversion process and the send process of the authentication result data becomes complicated, and it becomes difficult for an infinite number of compound machines, PCs and management servers to use the authentication result data.

This problem is common to information processing apparatuses having a configuration similar to that of the image forming apparatus.

### SUMMARY OF THE INVENTION

An object of the present invention is to provide an image forming apparatus and an information processing apparatus for easily performing authentication by using an authentication method according to a user's demand, and for easily realizing various combinations of an authentication method and a use restriction method. In addition, the object is to provide an image forming apparatus and an information processing apparatus that can send an authentication result by using a simple calling procedure without considering differences of software and hardware, so that the authentication result can be easily used by an infinite number of compound machines, PCs and management servers on an network.

The above-object can be achieved by an image forming apparatus or an information processing apparatus including an authentication part for referring to predetermined information and performing authentication of a user who uses an application by using a method according to the predetermined information.

According to the present invention, since the predetermined information is referred to, and an authentication method can be used according to the information. Thus, an authentication method according to a user's demand can be provided quickly.

The above-mentioned image forming apparatus or information processing apparatus may further includes: a XML conversion part for converting information obtained by the authentication control service into information of a XML format; and a message sending part for generating a SOAP message from the information of the XML format and sending the SOAP message to a destination on a network on the basis of the SOAP protocol.

### BRIEF DESCRIPTION OF THE DRAWINGS

Other objects, features and advantages of the present invention will become more apparent from the following detailed description when read in conjunction with the accompanying drawings, in which:

FIG. 1 shows a block diagram of a compound machine according to an embodiment 1;

FIG. 2 shows a hardware configuration of a main part of the compound machine 100 according to the embodiment 1;

FIG. 3 shows a software configuration of the information processing apparatus 1;

FIG. 4 is a block diagram showing a main configuration of the compound machine according to the embodiment 1 of the present invention;

FIG. 5 shows a data structure of user data registered in the user database in the example of FIG. 4;

FIG. 6 is a figure showing a state in which the authentication/use restriction file 222, the billing file 223 and the log file 224 are integrated;

FIG. 7 shows a structure of a SOAP message generated by the SOAP proxy 221 of the NCS 128;

FIG. 8 is a figure showing the whole configuration of the embodiment 1-2 of the present invention;

FIG. 9 shows setting information 225 in the embodiment 1-2 of the present invention;

FIG. 10 shows an example of use restriction information stored in the use restriction information server 151;

FIG. 11 shows a hardware configuration in the case when the fingerprint authentication is performed and the LDAP server connected to the Internet is used as the use restriction information server;

FIG. 12 shows a procedure from the authentication process to the SOAP message sending process by the compound machine 100;

FIG. 13 is a figure showing a process procedure between the CCS 129 and the authentication server 150 in the authentication process in the embodiment 1-2 of the present invention;

FIG. 14 is a figure showing a process procedure between the CCS 129 and the use restriction information server 151 in the use restriction process in the embodiment 1-2 of the present invention;

FIG. 15 is a figure showing a process procedure between the CCS 129 and the log/billing server in the billing process in the embodiment 1-2 of the present invention;

FIG. 16 is a figure showing a process procedure between the CCS 129 and the log/billing server 152 in the logging process in the embodiment 1-2 of the present invention;

FIG. 17 shows a block diagram showing a network configuration of an image forming system according to the embodiment 2 of the present invention;

FIG. 18 shows a data structure of the SOAP request message that is sent by the management server 720 and is received by the compound machine 100 according to the embodiment 2 of the present invention;

FIG. 19 shows processes by the configured image forming system of the embodiment 2 from process result request to process result sending.

### DETAILED DESCRIPTION OF THE PREFERRED EMBODIMENTS

In the following, preferred embodiments of the present invention will be described with reference to figures.

(Configuration of Embodiment 1)

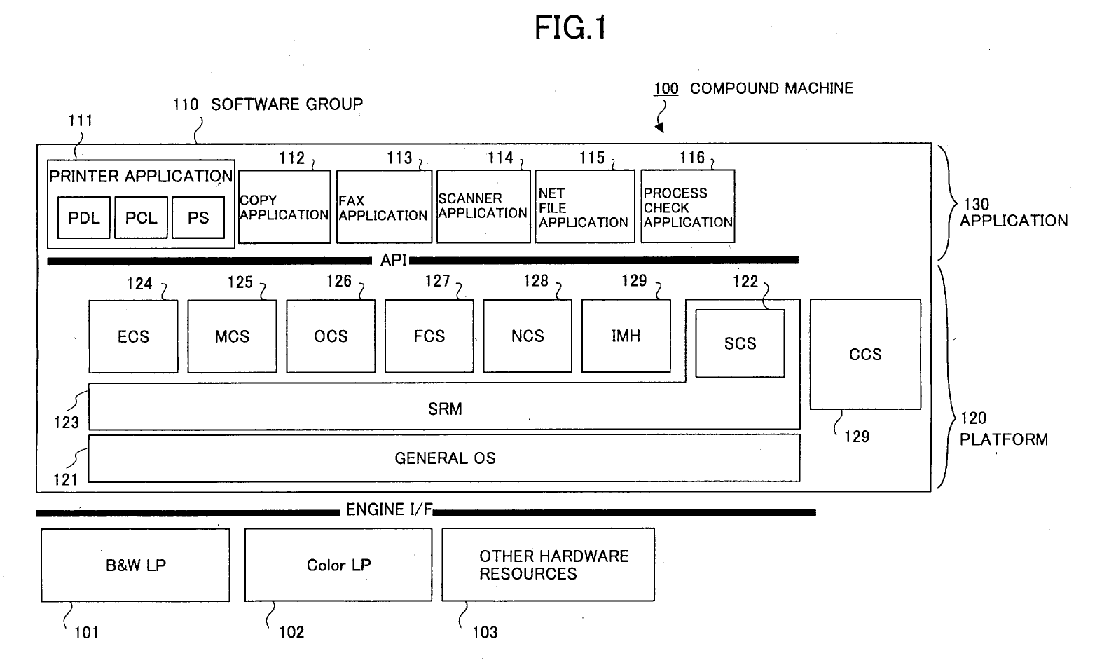

FIG. 1 shows a block diagram of the compound machine according to the embodiment 1.

As shown in FIG. 1, the compound machine 100 includes hardware resources and a software group 110. The hardware resources include a black and white line printer (B&W LP) 101, a color line printer 102, and a scanner, a facsimile, a hard disk and a network interface and the like. The software group 110 includes a platform 120 and applications 130.

The platform 120 includes control services for interpreting a processing request from an application so as to issue an acquiring request for hardware resources, a system resource manager (SRM) 123 for managing one or more hardware resources and arbitrating acquiring requests from the control services, and a general-purpose OS 121.

The control services include a plurality of service modules including a system control service (SCS) 122, an engine control service (ECS) 124, a memory control service (MCS) 125, a fax control service (FCS) 127, and a network control service (NCS) 128, and a certification control service (CCS 129, that can be also referred to as authentication control service). In addition, the platform 120 has application program interfaces (API) that can receive process requests from the applications 130 by using predetermined functions.

The general purpose OS 121 is a general purpose operating system such as UNIX, and can execute each piece of software of the platform 120 and the applications 130 concurrently as processes.

The process of the SRM 123 is for performing control of the system and performing management of resources with the SCS 122. The process of the SRM 123 performs arbitration and execution control for requests from the upper layer that uses hardware resources including engines such as the scanner part and the printer part, a memory, a HDD file, a host I/Os (Centronics I/F, network I/F IEEE1394 I/F, RS232C I/F and the like).

Specifically, the SRM 123 determines whether the requested hardware resource is available (whether it is not used by another request). When the requested hardware resource is available, the SRM 123 notifies the upper layer that the requested hardware resource is available. In addition, the SRM 123 performs scheduling for using hardware resources for the requests from the upper layer, and directly performs processes corresponding to the requests (for example, paper transfer and image forming by a printer engine, allocating memory area, file generation and the like).

The process of the SCS 122 performs application management, control of the operation part, display of system screen, LED display, resource management, and interrupt application control. The process of the ECS 124 controls hardware resources including the white and black line printer (B&W LP) 101, the color line printer (Color LP) 102, the scanner, and the facsimile. The process of the MCS 125 obtains and releases an area of the image memory, uses the hard disk apparatus (HDD), and compresses and expands image data.

The process of the FCS 127 provides APIs for sending and receiving of a facsimile from each application layer of the system controller by using a PSTN/ISDN network, for registering/referring of various kinds of facsimile data managed by BKM (backup SRAM), for facsimile reading, for facsimile receiving and printing, and for mixed sending and receiving.

The NCS 128 is a process for providing services commonly used for applications that need the network I/O. The NCS 128 distributes data received from the network by each protocol to a corresponding application, and acts as mediation between the application and the network when sending data to the network. Specifically, the process of the NCS 128 includes server daemons such as ftpd, httpd, lpd, snmpd, telnetd, and smtpd. In addition, the process of the NCS 128 includes client functions of the protocols. In addition, NCS 128 includes a SOAP (Simple Object Access Protocol) proxy and a SOAP listener for sending and receiving data via a network by using SOAP protocol. This feature will be described later.

The process of CCS 129 performs authentication process of a user, use restriction process, billing process and logging process. In addition, the CCS 129 converts each result of the processes into XML format, and generates an authentication/use restriction status file, a billing file and a log file in a hard disk (HD).

There are various methods for performing each of the authentication process, use restriction process, billing process and logging process. It can be set beforehand as setting information what method is used for performing each process. The process of the CCS 129 refers to the setting information and performs the process by using a method corresponding to the setting information. Details of the CCS 129 will be described later.

The OCS 126 controls an operation panel that is a means for transferring information between the operator (user) and control parts of the machine. In the compound machine 100 of the embodiment, the OCS 126 includes an OCS process part and an OCS function library part. The OCS process part obtains an key event, which indicates that the key is pushed, from the operation panel, and sends a key event function corresponding to the key event to the SCS 122. The OCS function library registers drawing functions and other functions for controlling the operation panel, in which the drawing functions are used for outputting various images on the operation panel on the basis of a request from an application 130 that has control right or from the control service. When the application 130 is developed, functions in the OCS function library is linked to an object program that is generated by compiling a source code file of the application 130, so that an executable file of the application 130 is generated.

The OCS 126 can be configured such that the whole of the OCS 126 operates as a process, or such that the whole of the OCS 126 is formed by the OCS function library.

The application 130 includes a printer application 111 that is an application for a printer having page description language (PDL) and PCL and post script (PS), a copy application 112, a fax application 113 that is an application for facsimile, a scanner application 114 that is an application for a scanner, a network file application 115 and a process check application 116. Each of the applications 130 is launched as a process by an initializing part (not shown in the figure) when the compound machine 100 is launched.

Interprocess communication is performed between a process of the application 130 and a process of the control service, in which a function is called, a returned value is sent, and a message is sent and received. By using the interprocess communication, user services for image forming processes such as copying, printing, scanning, and sending facsimile are realized.

As mentioned above, the compound machine 100 of the embodiment 1 includes a plurality of applications 130 and a plurality of control services, and each of those operates as a process. In each process, one or more threads are generated and the threads are executed in parallel. The control services provide common services to the applications 130. User services on image formation such as copying, printing, scanning and sending facsimile are provided while the processes are executed in parallel, the threads are executed in parallel, and interprocess communication is performed. A third party vendor can develop an application for the compound machine 100, and can executes the application in an application layer on the control service layer in the compound machine 100.

In the compound machine 100 according to the embodiment 1, although processes of a plurality of applications 130 and processes of a plurality of control services operate, processes can be configured as a single process for each of the applications and the control services. In addition, without providing any application in the compound machine 100, an application can be installed via a network. In addition, the application can be added or deleted.

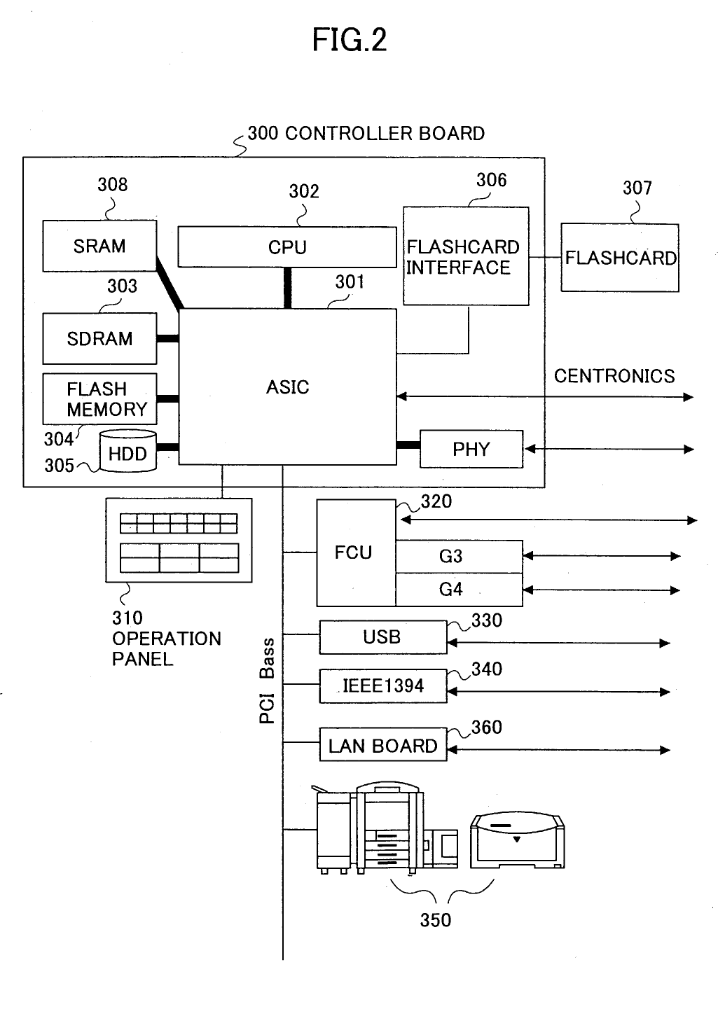

FIG. 2 shows a hardware configuration of a main part of the compound machine 100 according to the embodiment 1. As shown in FIG. 2, the compound machine 100 includes a controller board 300, an operation panel 310, a fax control unit (FCU) 320, a USB 330, a LAN board 360 (support 100BASE-TX/10BASE-T, wireless LAN and the like), an IEEE1394 340, and a printer 350 and the like. The controller board 300 includes a CPU 302, a SDRAM 303, a SRAM 308, a flash memory (flash ROM) 304, and a HD 305 and a flash card interface part 306 that are connected to the ASIC 301. The operation panel 310 is directly connected to the ASIC 301. The FCU 320, the USB 330, the IEEE1394 340 and the LAN board 360 and the printer 350 are connected to the ASIC 301 via the PCI bus.

As described later, when a server connected to a network is used as an authentication method, the compound machine connects to a LAN via the LAN board 360, and communicates with the server via the LAN and the network (the Internet for example). When a coin lack is used for use restriction, the coin lack is connected to the USB 330 for example.

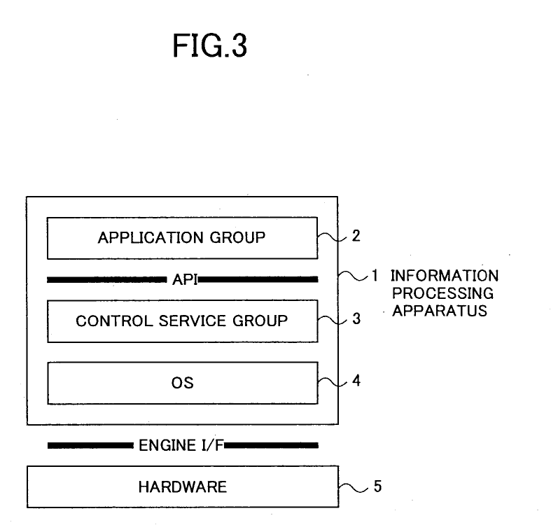

It is easy to replace the printer part 350 with other hardware in the image forming apparatus in FIG. 2. By replacing the printer part 350 with other hardware, the structure of FIG. 2 becomes an example of a general information processing apparatus that provides user services by using the hardware. In this case, in the software configuration of FIG. 1, control services and applications are used according to functions of the hardware. An example of a software configuration of the information processing apparatus 1 is shown in FIG. 3. In the same way as the configuration of FIG. 1, the configuration of FIG. 3 includes an application group 2, a control service group 3, an OS 4, and hardware resources 5.

(Embodiment 1-1)

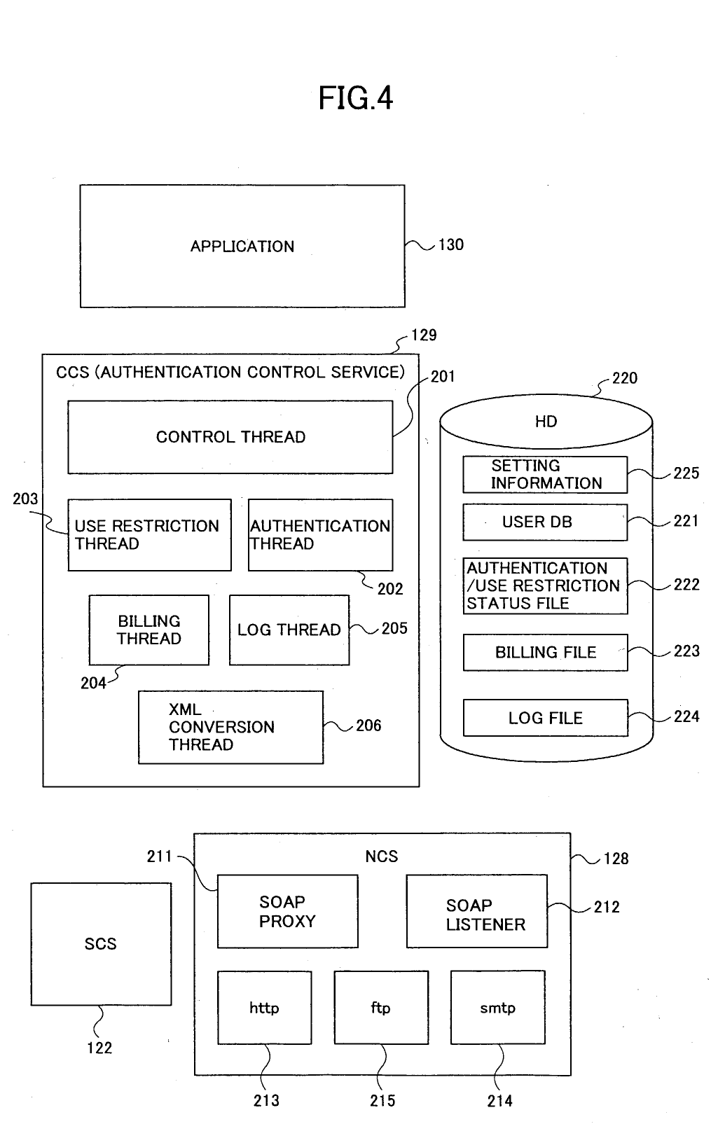

FIG. 4 is a block diagram showing a main configuration of the compound machine according to the embodiment 1 of the present invention. As shown in FIG. 4, the process of the CCS 129 includes a control thread 201, an authentication thread 202, a use restriction thread 203, a billing thread 204, a log thread 205, and a XML conversion thread 206 are generated and operated. Each of the authentication thread 202, the use restriction thread 203, the billing thread 204 and log thread 205 reads setting information 225 stored in the HD 220, and performs respective process according to the setting information. The control thread may read the setting information 225 so as to instruct each thread to perform a method according to the setting information 225.

FIG. 4 shows an example in which authentication and use restriction are performed by using information stored in the HD 220. First, function of each thread will be described with reference to FIG. 4.

The control thread 201 controls various functions of the CCS 129. By receiving authentication request from an application, the control thread 201 generates the authentication thread 202, the use restriction thread 203, the billing thread 204, the log thread 205 and the XML conversion thread 206, and the control thread requests processing to each thread. In addition, the control thread 201 performs selection process for an authentication method, and transmits and receives various information between the process of the SCS 122 by using interprocess communication. The control thread 201 may perform the process for setting the setting information 225.

The authentication thread 202 reads data of the setting information 225 stored in the HD 220, and authenticates the user by using an authentication method according to the data. In the example shown in FIG. 4, the setting information 225 indicates to refer to the user database 221 in the HD 220. The authentication thread 202 refers to the user database 221 on the basis of the setting information 225, performs authentication for each user, and generates authentication result (authentication OK, authentication NG and the like).

The use restriction thread 203 reads data of the setting information 225 stored in the HD 220, and performs use restriction by a method according to the data. In the example shown in FIG. 4, the use restriction thread 203 refers to the user database 221, determines whether an application that receives a launch request is an available application for the user, launches the application only when available, and restricts the use of the application when the application is not available. In addition, the use restriction thread 203 generates use restriction result (launched or restricted and the like).

The billing thread 204 reads data of the setting information 225 stored in the HD 220, and performs billing by using a billing method according to the data. In the example of FIG. 4, the billing thread 204 obtains data (available number of copies, number of copies that has been made and the like) on billing for usage of application for each user, and generates remaining number of copies that can be made as a billing result.

The log thread 205 reads data of the setting information 225 stored in the HD 220, and stores use history of an application for each user by using a log storing method (log storing destination and the like) according to the data. In the example shown in FIG. 4, the log is stored in the HD 220.

The XML conversion thread 206 converts each of the authentication result generated by the authentication thread 202 and the use restriction result generated by the use restriction thread 203 into XML format. Then, the XML conversion thread 206 stores the XML file in the HD 220 as an authentication/use restriction status file 222. In addition, the XML conversion thread 206 converts the use history generated by the log thread 205 into the XML format, and stores it into the HD 220 as the log file 224. The conversion into XML format is performed by a known method.

In the process of the NCS 128, threads of the SOAP proxy 211 and the SOAP listener 212 operate, and other than these, threads for providing services based on various protocols such as http, ftp, smtp operate.

The SOAP proxy 211 is a-message sending means. The SOAP proxy 211 includes the use restriction status file 222, the billing file 223, and the log file 224 which have the XML format. The SOAP proxy 211 generates a SOAP message including a URI (Uniform Resource Identifier) of other compound machine, PC or a management server on a network that are destination SOAP servers. Then, the SOAP proxy 211 sends the generated SOAP message to an address indicated in the SOAP message. For example, the-destination of the SOAP message can be set as the setting information 225.

The SOAP listener 212 is a message receiving means. The SOAP listener 212 receives a SOAP message and analyzes the received SOAP message. According to the analysis, the SOAP listener 212 selects a control service or an application, and notifies the selected control service or application of the SOAP message or a fact that the SOAP message is received. The SOAP listener 212 is used in the embodiment 2.

In relation to the CCS 129, the SCS 122 sends a request for initialization to the CCS 129, and displays an authentication screen when the authentication process is performed.

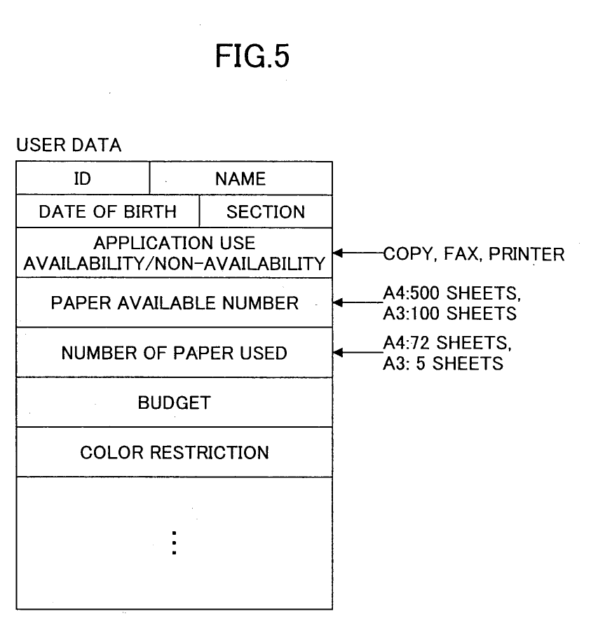

FIG. 5 shows a data structure of user data registered in the user database in the example of FIG. 4. In the user data, the ID field is referred to in the authentication process by the authentication thread 202. In the use restriction process, the use restriction thread 20 refers to the application use availability/non-availability field, a paper available number field and a color restriction field. In addition, in the billing process, the billing thread 204 refers to a budget field and the paper available number field.

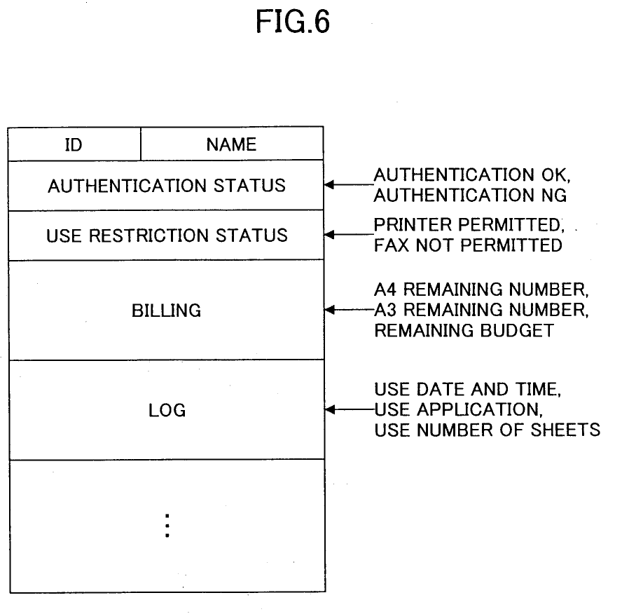

FIG. 6 is a figure showing a state in which the authentication/use restriction file 222, the billing file 223 and the log file 224 are integrated when the SOAP message is generated. Although, the files have the XML format, FIG. 6 shows only structure of the files, and tags of XML and the like are omitted. As shown in FIG. 6, in addition to ID and name, a file that is the main body of the message stores the authentication status (authentication OK, authentication NG) and the use restriction status (application name determined to be available, application name determined to be not available) read from the authentication/use restriction status file 222, billing information (remaining number of papers, remaining budged and the like) read from the billing file 223, and the log (use date and time, use application, used paper number and the like) read from the log file 224. Then, the SOAP message is generated from the file having such contents. Instead of integrating the authentication/use restriction file 222, the billing file 223, and the log file 224, for example, only the log file can be sent as the SOAP message.

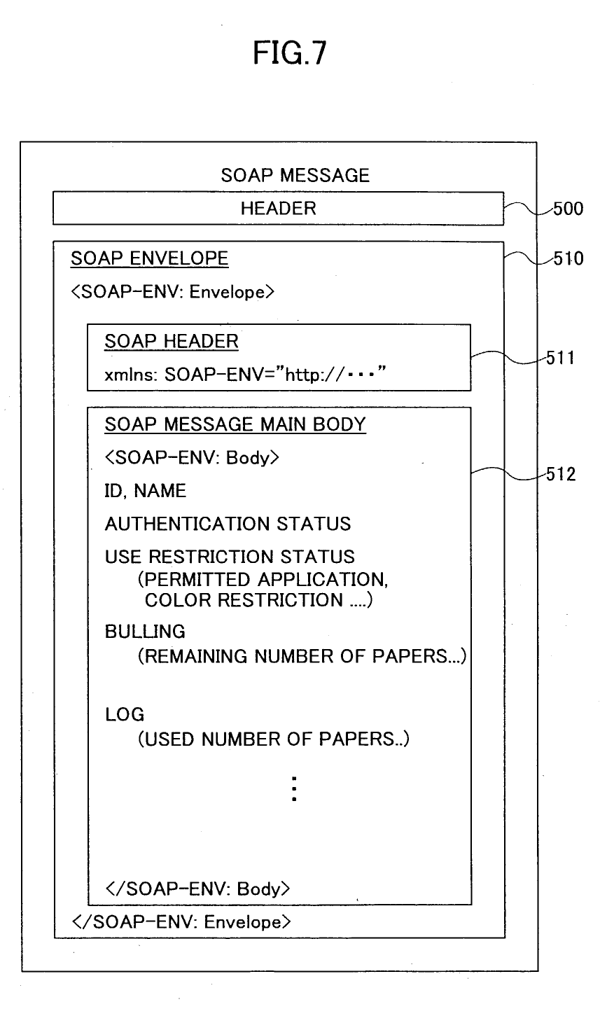

FIG. 7 shows the structure of the SOAP message generated by the SOAP proxy 221 of the NCS 128. As shown in FIG. 7, the SOAP message includes a header 500 and a SOAP envelop 510. In addition, the SOAP envelop 510 includes a SOAP header 511 and a SOAP message main body 512.

As shown in FIG. 7, a URI (Uniform Resource Identifier) that indicates the destination of the SOAP message is set in the SOAP header 511. The SOAP message main body 512 includes the contents shown in FIG. 6 by using the XML format as elements of <SOAP-ENV:Body> tag, in which the contents shown in FIG. 6 are the authentication/use restriction file 222, the billing file 223, and the log file 224.

(Embodiment 1-2)

In the embodiment 1-1, an example is shown in which authentication and use restriction are performed by using information of the user database 221 of the HD 220. In this embodiment 1-2, the authentication, use restriction and billing are performed by using a server connected to a network.

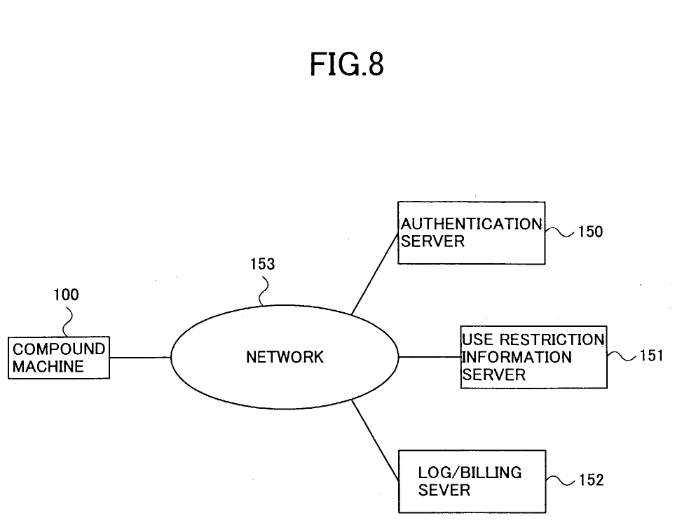

FIG. 8 is a figure showing the whole configuration of the embodiment 1-2. As shown in the figure, the system of the embodiment 1-2 includes a compound machine 100, an authentication server 150, a use restriction information server 151, a log/billing server 152 that are connected to a network 153 (for example, the Internet).

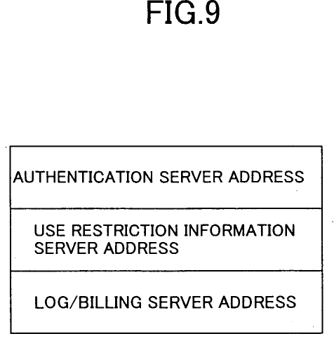

In the embodiment 1-2, only the setting information 225 in whole information in the HD 220 shown in FIG. 4 is stored in the HD 220. As shown in FIG. 9, in the embodiment 1-2, the setting information 225 includes an address of the authentication server 150, an address of the use restriction information server 151, and an address of the log/billing server 152. The authentication server 150 maintains user IDs of registered users, and the use restriction information server 151 maintains available application names for each user. The log/billing server 152 stores a log (use history) from the compound machine 100 for each user. In addition, billing can be performed by using the use history.

In the configuration of this embodiment, the authentication thread 202 shown in FIG. 4 obtains the authentication server address in the setting information 225, sends an ID input by the user to the authentication server by using the address. Then, the authentication server 150 performs user authentication by comparing a registered ID with the received ID, and sends the result to the authentication thread 202. The ID may be input manually from the operation panel, or it may be read from a card that is inserted in a card reading apparatus that is connected to the compound machine 100.

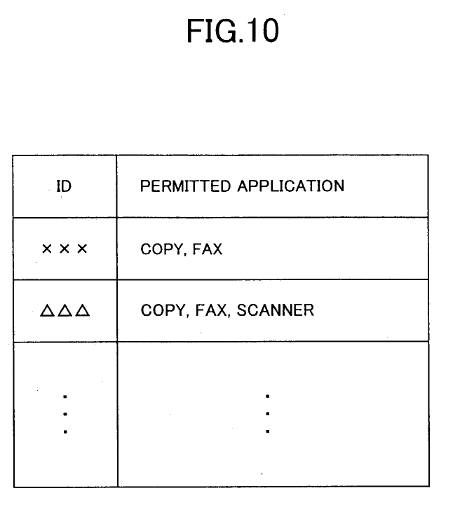

The use restriction thread 203 obtains the use restriction information server address in the setting information 225. Then, the use restriction thread 203 sends the ID of the user and an application name desired by the user to the use restriction information server 151 on the basis of the address. Then, the use restriction information server 151 determines availability/non-availability of the application by using the received ID, desired application and the use restriction information. The use restriction information server 151 sends the result to the use restriction thread 203. An example of the use restriction information stored by the use restriction information server 151 is shown in FIG. 10.

The billing thread 204 obtains the log/billing server address in the setting information 225, and sends information necessary for billing (count of copies that have been made, for example) to the log/billing server. The log/billing server 152 calculates remaining paper count by using available paper count and the received information, and sends the result to the billing thread 204.

The log thread 205 obtains the log/billing sever address in the setting information 225, and sends use history (for example, use date and time, using application, number of copies that have been made and the like) to the log/billing server 152. The log/billing server 152 stores the use history. Instead of providing the billing thread 204, the log/billing server 152 may perform billing process by using information from the log thread 205. The log/billing server 152 may have information on sections each user belongs to, so that the log/billing server 152 can easily perform billing for each user or for each section or the like in response to user's demand.

As described in the embodiment 1-1, SOAP can be used for sending/receiving information between the compound machine 100 and each server. Instead of using SOAP, TCP/IP protocol can be used for example.

In the above-mentioned configuration, the authentication server 150 and the use restriction information server 151 can be integrated into one server, so that user authentication and use restriction can be performed at a time.

In addition, a LDAP (Lightweight Directory Access Protocol) server can be used as the authentication 150 and/or the use restriction information server 151. The LDAP server is a server for providing a directory service according to a protocol based on the X.500 directory service and that is light-weighted for the Internet. For example, the LDAP server used as the use restriction information sever 151 stores personal information such as available applications for each user ID.

Fingerprint authentication can be used as the above-mentioned user authentication. In this case, a fingerprint authentication unit is connected to the compound machine 100 via the USB 330 for example, and a fingerprint of a user is registered in the authentication server 150. When performing authentication, a fingerprint is input by putting a user's finger on the fingerprint authentication unit. Then, the authentication thread 202 sends information of the fingerprint to the authentication server 150, in which the information is a feature extracted from the fingerprint by the authentication thread 202. The authentication sever 150 performs authentication by comparing registered fingerprint information with the received information. The fingerprint authentication unit may perform feature extraction of the fingerprint.

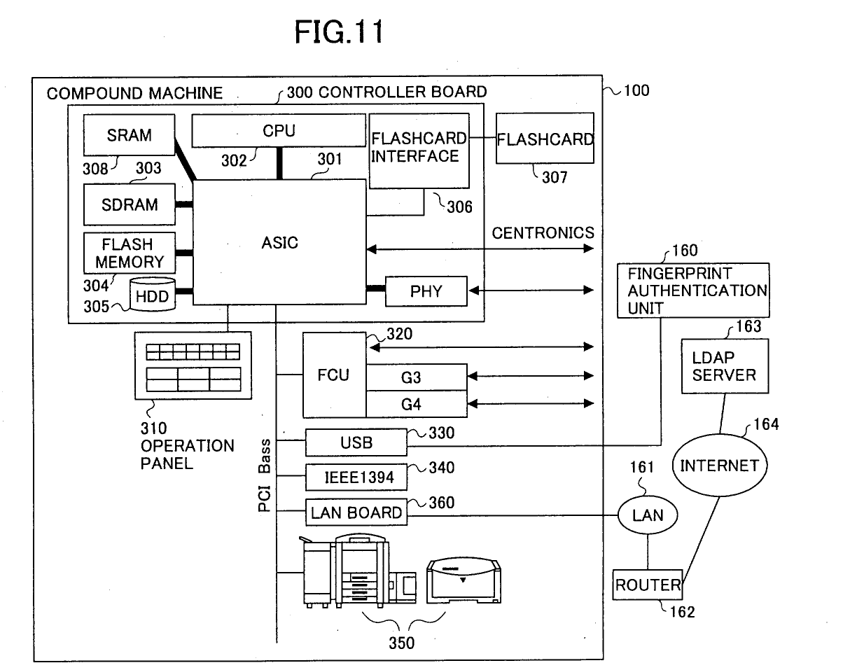

FIG. 11 shows a hardware configuration in the case when the fingerprint authentication is performed and the LDAP server connected to the Internet is used as the use restriction information server. As shown in the figure, a fingerprint authentication unit 160 is connected to the compound machine 100 via the USB 330. In addition, the LDAP server 163 is connected to the compound machine 100 via the Internet 164, a router 162, a LAN 161 and a LAN board 360. The connection method of the fingerprint authentication unit 160 is not limited to USB. In addition, the fingerprint authentication unit 160 may be included in the operation panel 310.

For performing the fingerprint authentication, a method other than the above-mentioned method can be adopted, in which fingerprint information is registered in the HD 220, and the fingerprint information is compared with input fingerprint information. In this case, the fingerprint information may be stored in a nonvolatile memory.

In addition, by connecting a coin lack, use restriction by using the coin lack can be performed. In this case, information indicating that use restriction is performed by using the coin lack is set in the setting information 225. The use restriction thread 203 reads the information, so that use restriction by using the coin lack can be performed. For example, a number of copies corresponding to money input into the coin lack is allowed, and when the number of copies reaches a permitted number, the use of the copy function of the compound machine is restricted.

(Process Procedure of Embodiment 1-1)

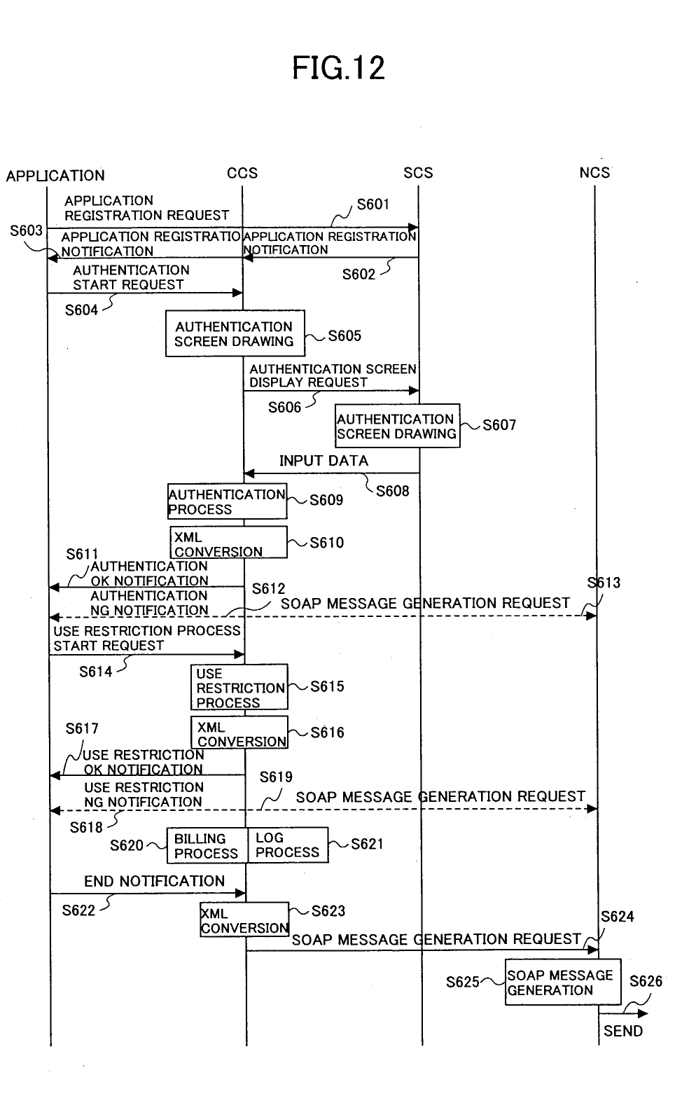

FIG. 12 shows a procedure from the authentication process to the SOAP message sending process by the thus configured compound machine 100. FIG. 12 shows a procedure performed in the configuration of the embodiment 1-1 shown in FIG. 4. That is, FIG. 4 shows a procedure in the case when authentication and use restriction are performed by using the user database 221 stored in the HD 220 of the compound machine 100. In the following procedure, each thread refers to the setting information 225, and determines to use the user database 221 stored in the HD 220.

When an application is launched, the application sends an application registration request message to the SCS 122 in step S601. When the SCS 122 receives the application registration request, the SCS 122 performs registration process for the application that sends the request, and sends an application registration notification message to the CCS 129 in step S602. The CCS 129 receives the application registration notification message, and sends the application registration notification message to the application that sent the request in step S603.

When the application is registered, the application sends an authentication request message to the CCS 129 in step S604. The control thread 201 of the CCS 129 receives the authentication request message, and generates a drawing message of an authentication screen in step S605. Then, the control thread 201 sends an authentication screen display request message with the image to the SCS 122 in step S606. When the SCS 122 receives the authentication screen display request message, the SCS 122 displays the authentication screen by outputting the drawing image on the operation panel in step S607.

When the user inputs the user ID, name and the like via the authentication screen displayed on the operation panel, the input data is sent to the CCS 129 via the SCS 122 in step S608. When the CCS 129 receives the input data, the control thread 201 passes the received input data to the authentication thread 202. The authentication thread 202 refers to the user database 221, and performs authentication process on the basis of the ID, name and the like in step S609. Then, the XML conversion thread 206 converts the authentication result (authentication OK, authentication NG) into the XML format, and stores in the HD 220 as the authentication/use restriction status file in step S610.

When the authentication succeeds, the authentication thread 202 sends an authentication OK notification message to the application in step S611. When the authentication fails, the authentication thread 202 sends an authentication NG message to the application in step S612. Then, the authentication thread 202 sends, to the NCS 128, a SOAP message generation request message of the authentication/use restriction status file 222 in which the authentication result is recorded as authentication NG in step S613.

The application that receives the authentication OK notification message sends a use restriction start request message to the CCS 129 for starting use restriction process in step S614. When the CCS 129 receives the use restriction start request message, the use restriction thread 203 refers to the user database 221, and performs use restriction by determining whether the application is available or not by the present user in step S615.

When the application receives the authentication NG message, execution of the application is terminated.

When the use restriction result is “available”, the use restriction thread 203 sends the use restriction OK notification message to the application in step S617. When the use restriction result is “not available”, the use restriction thread 203 sends the use restriction NG message to the application in step S618. The use restriction thread 203 sends a SOAP message generation request message of the authentication/use restriction status file 222 to the NCS 128, in which the use restriction result is not available in step S619.

When the application receives the use restriction OK notification message, a process specific for the application is started. At this time, CCS 129 performs concurrently the billing process by the billing thread 204 (step S620) and the logging process by the log thread 205 (step S621). When the application receives the use restriction NG notification message, the execution of the application is terminated.

When the application executes the specific process, and ends the process, the application sends an end notification message to the CCS 129 in step S622.

When the CCS 122 receives the end notification message, the XML conversion thread 206 converts the billing data and the history data into the XML format, and generates a billing file 223 and a log file 224 in the HD 220 in step S623.

Next, the control thread 201 in the CSS 129 sends a SOAP message generation request message to the NCS 128 for generating a SOAP message from the authentication/use restriction status file 221, the billing file 223 and the log file 224 stored in the HD 220 in step S624.

When the NCS 128 receives the SOAP message generation request message, the SOAP proxy integrates the files as shown in FIG. 6, and generates the SOAP message as shown in FIG. 7 in step S625. Then, the SOAP proxy 211 sends the generated SOAP message to a destination indicated by a URI in the SOAP header 511 in step S626.

(Process Procedure in Embodiment 1-2)

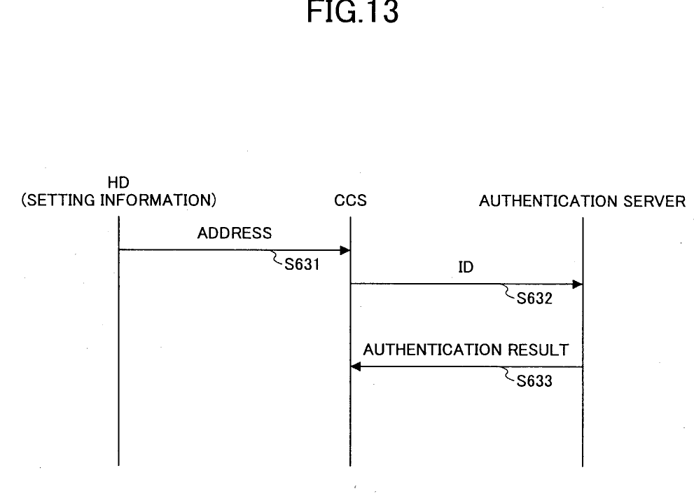

Next, process procedures in the configuration of the embodiment 1-2 shown in FIG. 8 will be described by using FIGS. 13-16. The process procedure in the embodiment 1-2 is different from that of the embodiment 1-1 in that a sever that is connected to a network is used for authentication process and the like. FIGS. 1316 shows the part of each process.

FIG. 13 is a figure showing a process procedure between the CCS 129 and the authentication server 150 in the authentication process (corresponding to step S609 in FIG. 12). As shown in FIG. 13, the CCS 129 reads an address of the authentication server 150 from the setting information stored in the HD 220 in step S631, and sends an ID input by the user to the authentication server 150 in step S632. The authentication server 150 performs authentication by comparing the received ID with a registered ID in step S633, and returns an authentication result to the CCS 129 in step S633.

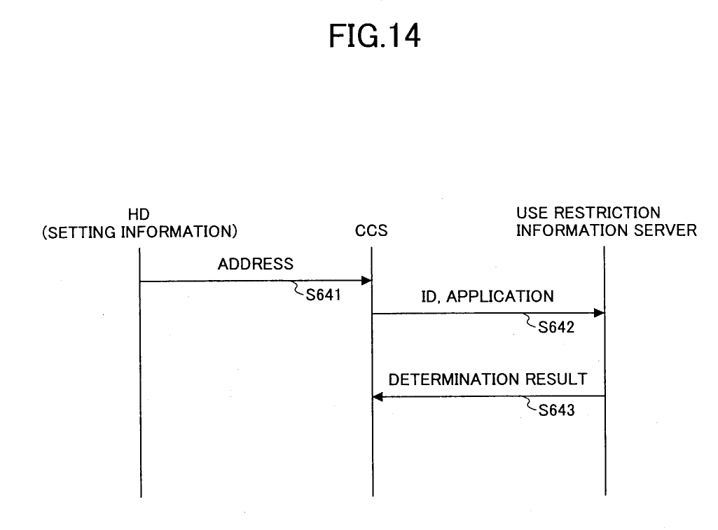

FIG. 14 is a figure showing a process procedure between the CCS 129 and the use restriction information server 151 in the use restriction process (corresponding to step S615 in FIG. 12). As shown in FIG. 14, the CCS 129 reads an address of the use restriction information server 151 from the setting information stored in the HD 220 in step S641, and sends an ID input by the user and identification of an application that the user wants to use to the use restriction information server 151 in step S642. The use restriction information server 151 determines whether the application can be used by the user by using the received ID and the identification, and sends the determination result to the CCS 129 in step S643.

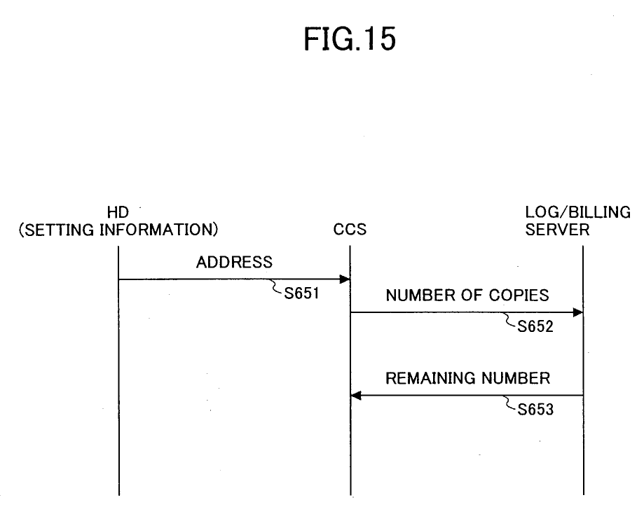

FIG. 15 is a figure showing a process procedure between the CCS 129 and the log/billing server in the billing process (corresponding to step S620 in FIG. 12). As shown in FIG. 15, the CCS 129 reads an address of the log/billing server 152 from the setting information stored in the HD 220 in step S651, and sends information necessary for billing to the log/billing server 152 in step S652. The information necessary for billing is, for example, current number of copies that have been made when copy application is used. The log/billing server 152 performs the billing process by using received information. For example, when performing copying, if there is an upper limit for available number of copies, available remaining number is calculated and sent to the CCS 129 in step S653. In addition, the log/billing server 152 also can perform processes for charging each user or each section according to the number of copies.

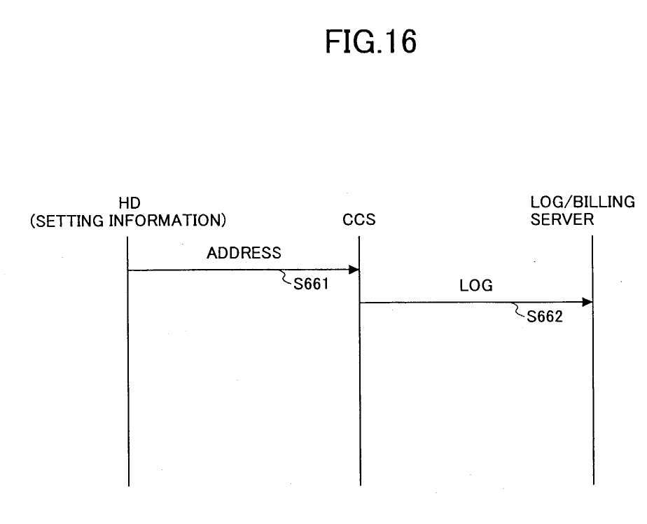

FIG. 16 is a figure showing a process procedure between the CCS 129 and the log/billing server 152 in the logging process (corresponding to step S621 in FIG. 12). As shown in FIG. 16, the CCS 129 reads an address of the log/billing server 152 from the setting information stored in the HD 220 in step S661, and sends use history (log) to the log/billing server 152 in step S662. When information shown in FIG. 6 is generated and the information is sent to a management server by using the SOAP message, the log remains in the HD 220 in the same way as the embodiment 1-1.

As mentioned above, according to the compound machine 100, it becomes possible to access an server having an address set as the setting information 221 and to perform authentication and use restriction. Therefore, for example, when a different use restriction method is provided by a different server and when a user wants to use the different use restriction method, the different use restriction method can be provided only by changing the address of the use restriction information server in the setting information 221. In addition, other than the address, by setting, in the setting information 221, information indicating that a coin lack, key counter or key card or the like is used, the use restriction can be performed by using the coin lack, key counter or key card or the like. Thus, according to the compound machine 100, an authentication method and a use restriction method can be quickly provided according to a user's demand.

In addition, according to the compound machine 100, each process result is converted into the XML format that is a standard specification by using the XML conversion thread 206, and the result is sent to a specified URI by using SOAP protocol by generating the SOAP message by the SOAP proxy 211 of the NCS 128. Thus, process results can be sent and received among an indefinite number of compounds machines, PCs and management servers on a network by using the standard specification. Therefore, information on the process result generated by a compound machine 100 can be easily used by any apparatus on the network for any use.

In addition, according to the compound machine 100 of the embodiment 1, since the process result is sent by using SOAP, it is not necessary to generate and send the process result in consideration for differences of software, hardware and protocol, so that the process result data can be sent by using a simple calling procedure. Therefore, data generated by a compound machine can be easily used by any apparatus on the network for any use.

(Embodiment 2)

According to the compound machine 100 of the embodiment 1, the process result data is simply sent to a compound machine and the like having a specified address on a network by using SOAP. On the other hand, the compound machine of the second embodiment receives a request for process result data from a compound machine, a PC or a management server on a network. The process result data includes result data of authentication process, use restriction process, billing process and logging process. Then, the compound machine performs each process and sends the process result by using SOAP.

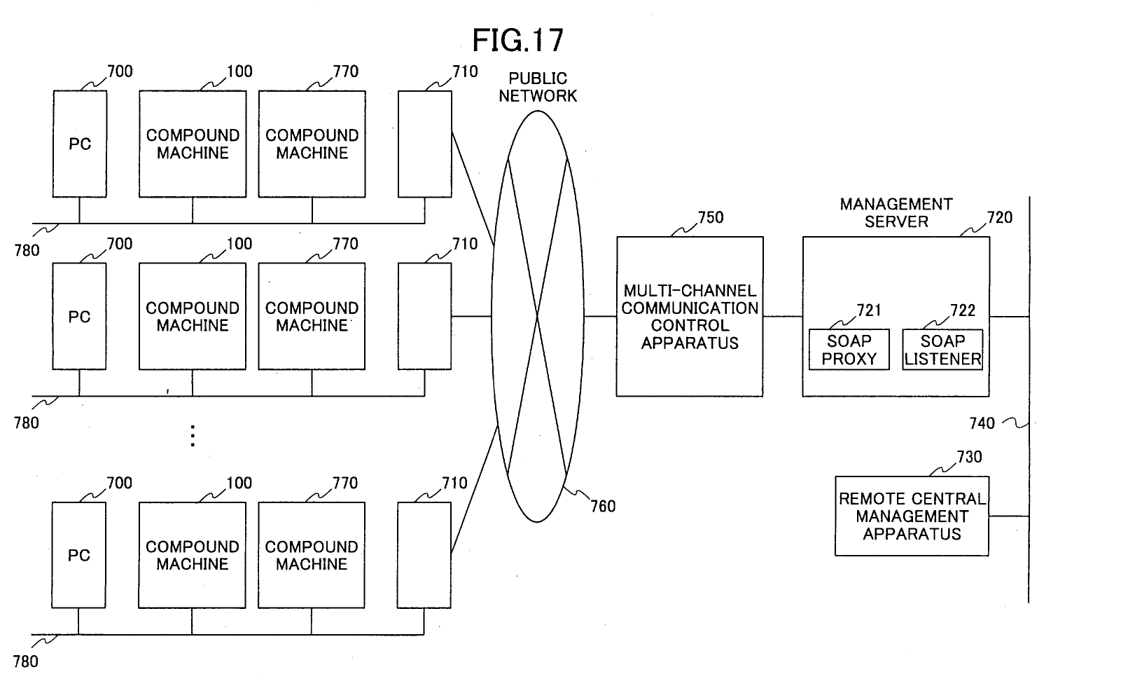

FIG. 17 shows a block diagram showing a network configuration of an image forming system according to the embodiment 2. As shown in FIG. 17, in the image forming system of the embodiment 2, a management server 720 and a plurality of pairs of compound machines 100 and 770 are connected by a public network 760. In addition, the management server 720 is connected to a remote central management apparatus 730 via a network such as an Ethernet 740.

Each of the compound machines 100 and 770 is the same as the compound machine 100 of the embodiment 1. Each of the compound machines includes the CCS 129 and the NCS 128 same as those shown in FIG. 4. Different IP addresses or URIs are assigned to the compound machines 100 and 770.

The compound machine 100 includes the SOAP listener 212 and the SOAP proxy in the NCS 128. The SOAP listener 212 receives a SOAP request message from a PC 700, other compound machine 770 or the management server 720, and analyzes the SOAP request message, and sends a process request to the CCS 129. The SOAP proxy 211 generates a SOAP response message including process result data from authentication/use restriction status file 221, the billing file 223 and the log file 224, and returns the SOAP response message to a destination that sent the SOAP request message. Thus, the compound machine functions as a SOAP server.

The public network 760 is connected to the multi-channel communication control apparatus 750 that is connected to the management server 720. In addition, a plurality of the pairs of the compound machines 100 and 770 are connected to the multi-channel communication control apparatus 750 via the communication controllers 710. The PC 700 that is a printer client is connected to the compound machine 100 and 770 via a network such as the Ethernet 780. The PC 700 also includes the SOAP proxy and the SOAP listener (which are not shown in the figure) for realizing data exchange by SOAP.

The communication controller 710 is connected to a facsimile or a normal telephone in a customer site. When the facsimile and the telephone are not used (when the line is available), data communication (off-talk communication) is available between the multi-channel communication control apparatus 750 and the communication controller 710 via the public network 760. The Internet can be also used as the public network 760. In addition, a local area network can be used for connecting between the compound machines 100, 770 and the management server 720. That is, the LANs 740 and 760 may exist on one network. In addition, a private line can be used for connecting between the compound machines 100, 770 and the management server 720. When the Internet is used as the public network 760, communication can be performed without using the off-talk communication method.

The management server 720 collects the process result data from the plurality of compound machines 100, 770 as the SOAP response messages, and sends the SOAP response messages to the remote central management apparatus 730 via the LAN 740. The management server 720 is connected to the public network 760 by the multi-channel communication control apparatus (CCU) 750.

The configuration of the management server 720 is the same as that of a normal computer such as a workstation for example. As shown in FIG. 17, the management server 720 includes the SOAP proxy 721 and the SOAP listener 722 for realizing data exchange by SOAP.

That is, the management server 720 generates a SOAP request message for requesting a process result by using the SOAP proxy 721, and sends the SOAP request message to the compound machine 100. In addition, the management server 720, by using the SOAP listener 722, receives a SOAP response message including the process result data from the compound machine 100, analyzes the SOAP response message, and sends the message to the remote central management apparatus 730.

The remote central management apparatus 730 receives process result data of a plurality of compound machines collected by the management server 720 from the management server 720 via the Ethernet 740, and collectively manages the process result data.

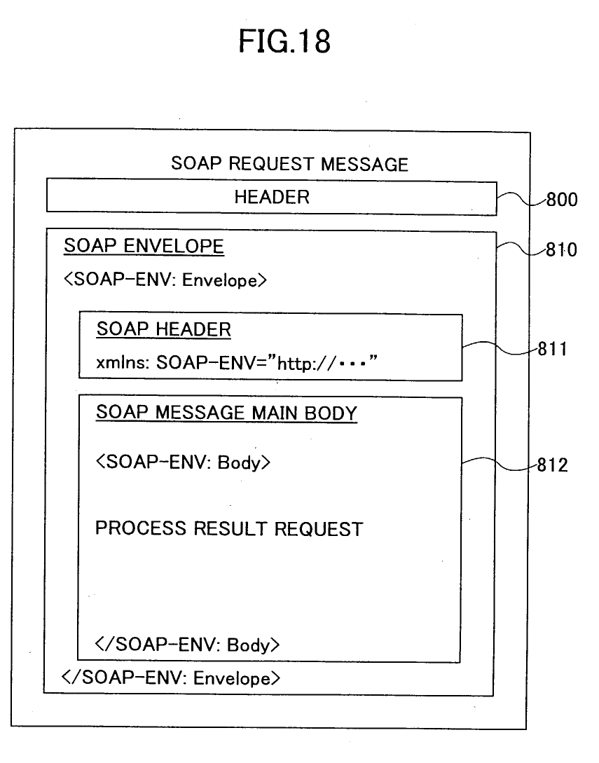

Next, the SOAP request message and the SOAP response message will be described. FIG. 18 shows a data structure of the SOAP request message that is sent by the management server 720 and is received by the compound machine 100. The SOAP request message includes a header 800 and a SOAP envelope 810 in the same way as the embodiment 1. The SAOP envelope 810 includes a SOAP header 811 and a SOAP message main body 812. As shown in FIG. 18, the SOAP message of this embodiment is different from that of the embodiment 1 in that a process result request is described as an element of a <SOAP-ENV:Body> tag in the SOAP message main body. Similar to the SOAP response message (FIG. 7) of the compound machine 100 of the embodiment 1, process result is described in the SOAP message main body in the SOAP response message of this embodiment.

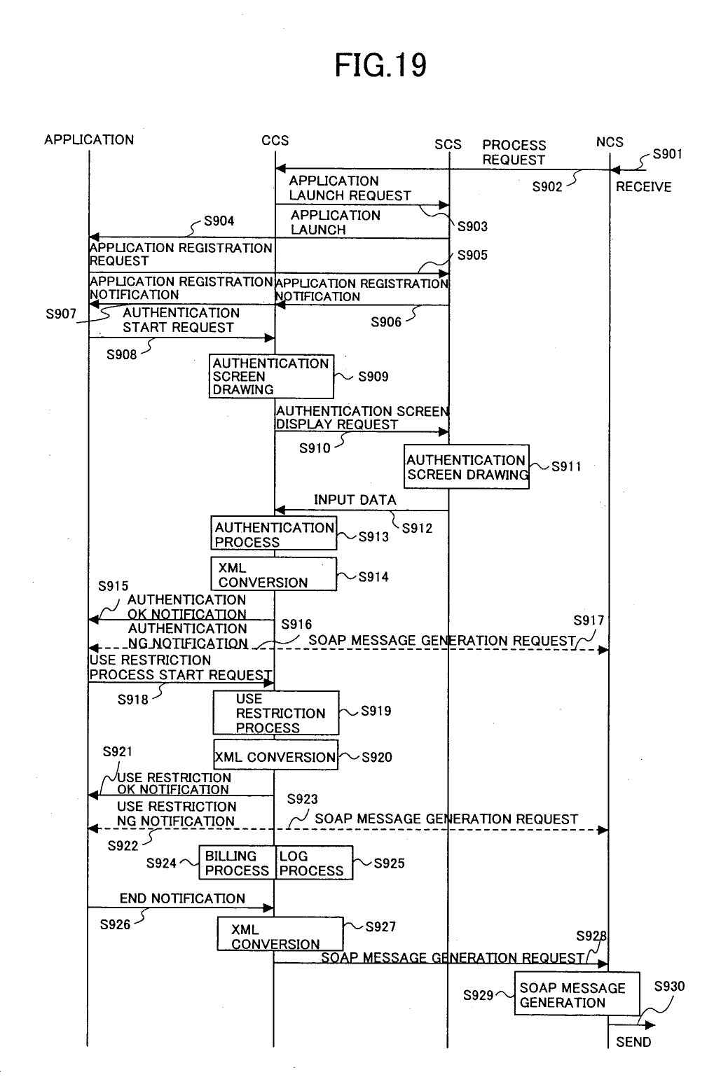

In the following, processes by the thus configured image forming system of the embodiment 2 will be described from process result request to process result sending. FIG. 19 shows the processes. It is assumed that the compound machine 100 of the embodiment 2 receives the process result request by the SOAP request message from the management sever 720. As the authentication process (S913), use restrict process (S919), billing process (S924) and logging process (S925) in FIG. 19, either of the process the embodiment 1-1 or the process of the embodiment 1-2 can be performed.

When the SOAP listener 212 of the NCS 128 receives the SOAP request message in step S901, the SOAP listener 212 analyzes the contents of the message. When it is determined that the SOAP request message indicates a process result request, a process request message is sent to the CCS 129 in step S902.

When the CCS 129 receives the process request message, the CCS 129 sends an application launch request message to the SCS 122 by the control thread 201 in step S903. When the SCS 122 receives the application launch request message, the SCS 122 launches every application in the compound machine 100 in step S904. Each of the launched applications sends an application registration request message to the SCS 122 in step S905. After that, authentication process, use restriction process, billing process, and logging process are performed by the CCS 129 according to use of applications by the user. The processes are the same as those (steps S602-S624) described by using FIG. 12 in the embodiment 1.

Finally, the SOAP response message having the same structure as that shown in FIG. 7 is generated by the SOAP proxy 211 in step S929. The SOAP response message including process result data is sent to the management server 720 that sent the SOAP request message in step S930. The above-mentioned process is performed also when the SOAP request message is received from the PC 700 or the other compound machine.

As mentioned above, the compound machine 100 of the embodiment 2 receives the SOAP request message from the management server 720 by the SOAP listener 212 of the NCS 128. The received SOAP request message is analyzed, and a process request is sent to the CCS 129. The CCS 129 receives the process request and performs authentication process, use restriction process, billing process and logging process for the user using the application. Then, the CCS 129 generates the SOAP response message and sends the message to the management server 720 corresponding to a specified URI. Thus, the compound machine 100 operates as a SOAP server, and an indefinite number of SOAP clients on the network such as the management server 720 can handle the information of the process result on the basis of the standard specification, so that information of the process result generated by a compound machine can be used in any apparatus on the network and for any purpose.

In addition, the compound machine 100 of the embodiment 2 sends authentication status information to clients such as the management server 720, the compound machine 770 and the PC 700 on a network by using the SOAP protocol based on XML that is independent of software and hardware. Thus, the authentication status information can be sent by using a simple calling procedure.

In the above-mentioned embodiment, although the CCS performs the authentication process, use restriction process, billing process and logging process, whole or a part of the processes in the authentication process, the use restriction process, the billing process and the logging process can be realized by using one or more applications. The program of the application can be distributed by using a recording medium such as an IC card or via a network. By loading the program on the compound machine and executing the program, the authentication process and the like described in the embodiments of the present invention can be performed.

As mentioned above, according to the present invention, it can be easily realized to perform authentication by using an authentication method according to user's demand and to perform desired combination of an authentication method and a use restriction method. In addition, an image forming apparatus and an information processing apparatus for easily communicating with an indefinite number of compound machines, PCs and management servers on an network without consideration of differences of software and hardware can be provided.

As mentioned above, according to the present invention, the image forming apparatus includes an authentication part for referring to predetermined information and performing authentication of a user who uses an application by using a method according to the predetermined information.

According to the present invention, since the predetermined information is referred to, and an authentication method can be used according to the information. Thus, an authentication method according to a user's demand can be provided quickly.

In the image forming apparatus, the authentication part performs authentication of the user by using the method when the authentication part receives a process request from a client connected to the image forming apparatus via a network. Since authentication is performed when the process request is received by a client, the process can be performed as necessary.

In the image forming apparatus, the predetermined information includes an address of a server that stores user identification information, the authentication part sends user identification information input into the image forming apparatus to the server by using the address, and receives an authentication result from the server. Therefore, user authentication can be performed by an authentication server connected to a network. The server may be a LDAP server. By using the LDAP server, a directory service relating to authentication can be easily provided.

The image forming apparatus may include a use restriction part for referring to predetermined information and performing use restriction by determining whether a user is permitted to use an application by using a method according to the predetermined information. since the predetermined information is referred to, and a use restriction method can be used according to the information. Thus, a use restriction method according to a user's demand can be provided quickly.

In the image forming apparatus, the use restriction part determines whether the user is permitted to use the application by using the method when the use restriction part receives a process request from a client connected to the image forming apparatus via a network. Since use restriction is performed when the process request is received by a client, the process can be performed as necessary.

The image forming apparatus may further include a billing part for referring to predetermined information and performing a billing process on the basis of usage of the application by the user by using a method according to the predetermined information. Since the predetermined information is referred to, and a billing method can be used according to the information. Thus, a billing method according to a user's demand can be provided quickly.

In the image forming apparatus, the billing part performs the billing process by using the method when the billing part receives a process request from a client connected to the image forming apparatus via a network. Since billing is performed when the process request is received by a client, the process can be performed as necessary.

The image forming apparatus may further include a logging part for referring to predetermined information and storing a use history of the application in an apparatus according to the predetermined information. Since the predetermined information is referred to, and the log can be stored in an apparatus according to the information. Thus, use history can be effectively used.

In the image forming apparatus, the logging part stores the use history in the apparatus when the logging part receives a process request from a client connected to the image forming apparatus via a network. Since logging is performed when the process request is received by a client, the process can be performed as necessary.

The image forming apparatus includes an authentication control service that operates between the applications and the hardware resources, and the authentication control service includes the authentication part. According to the present invention, services on authentication can be easily provided regardless of kinds of applications.

The above-mentioned image forming apparatus may further includes: a XML conversion part for converting information obtained by the authentication control service into information of a XML format; and a message sending part for generating a SOAP message from the information of the XML format and sending the SOAP message to a destination on a network on the basis of the SOAP protocol.

Accordingly, since information can be sent on the basis of SOAP in which XML format that is standard specification is used as data-exchange format, an infinite number of image forming apparatuses, PCs and management servers can handle the information on the basis of the standard specification, so that authentication status information generated by an image forming apparatus can be easily used in any point on the network for any purpose. In addition, since the information is sent to the compound machine and the PC on the network by using XML based SOAP that is independent of software and hardware, the information can be sent by using a simple calling procedure.

The image forming apparatus may further includes: a message receiving part for receiving a SOAP request message from a client connected to a network, analyzing the SOAP request message and notifying the authentication control service of a process request. Thus, the image forming apparatus can operate as a SOAP server.

In addition, according to the present invention, a method used for the image forming apparatus can be provided. In addition, a program for causing the image forming apparatus to perform the processes of the present invention is provided. In addition, a recording medium storing the program is provided. In addition, according to the present invention, an information processing apparatus, and a method and a program for the information processing apparatus can be provided in the same way as the above-mentioned image forming apparatus.

The present invention is not limited to the specifically disclosed embodiments, and variations and modifications may be made without departing from the scope of the present invention.

What is claimed is:

1. An image forming apparatus including hardware resources used for image forming processes and applications for performing image forming processes, the image forming apparatus comprising:
an authentication part for referring to predetermined information and performing authentication of a user who uses an application by using a method according to the predetermined information.

2. The image forming apparatus as claimed in claim 1, wherein the authentication part performs authentication of the user by using the method when the authentication part receives a process request from a client connected to the image forming apparatus via a network.

3. The image forming apparatus as claimed in claim 1, wherein the predetermined information includes an address of a server that stores user identification information, the authentication part sends user identification information input into the image forming apparatus to the server by using the address, and receives an authentication result from the server.

4. The image forming apparatus as claimed in claim 3, wherein the server is a LDAP server.

5. The image forming apparatus as claimed in claim 1, the image forming apparatus further comprising a use restriction part for referring to predetermined information and performing use restriction by determining whether a user is permitted to use an application by using a method according to the predetermined information.

6. The image forming apparatus as claimed in claim 5, wherein the use restriction part determines whether the user is permitted to use the application by using the method when the use restriction part receives a process request from a client connected to the image forming apparatus via a network.

7. The image forming apparatus as claimed in claim 1, the image forming apparatus further comprising a billing part for referring to predetermined information and performing a billing process on the basis of usage of the application by the user by using a method according to the predetermined information.

8. The image forming apparatus as claimed in claim 7, wherein the billing part performs the billing process by using the method when the billing part receives a process request from a client connected to the image forming apparatus via a network.

9. The image forming apparatus as claimed in claim 1, the image forming apparatus further comprising a logging part for referring to predetermined information and storing a use history of the application in an apparatus according to the predetermined information.

10. The image forming apparatus as claimed in claim 9, wherein the logging part stores the use history in the apparatus when the logging part receives a process request from a client connected to the image forming apparatus via a network.

11. The image forming apparatus as claimed in claim 1, the image forming apparatus includes an authentication control service that operates between the applications and the hardware resources, and the authentication control service includes the authentication part.

12. The image forming apparatus as claimed in claim 11, the image forming apparatus further comprising:
a XML conversion part for converting information obtained by the authentication control service into information of a XML format; and
a message sending part for generating a SOAP message from the information of the XML format and sending the SOAP message to a destination on a network on the basis of the SOAP protocol.

13. The image forming apparatus as claimed in claim 12, wherein the message sending part sends the SOAP message to a management apparatus on the network that manages a plurality of image forming apparatuses.

14. The image forming apparatus as claimed in claim 12, the image forming apparatus further comprising:
a message receiving part for receiving a SOAP request message from a client connected to a network, analyzing the SOAP request message and notifying the authentication control service of a process request.

15. An authentication method used in an image forming apparatus including hardware resources used for image forming processes and applications for performing image forming processes, the authentication method comprising:
an authentication step of referring to predetermined information and performing authentication of a user who uses an application by using a method according to the predetermined information.

16. The authentication method as claimed in claim 15, wherein the image forming apparatus performs authentication of the user by using the method according to the predetermined information in the authentication step when the image forming apparatus receives a process request from a client connected to the image forming apparatus via a network.

17. The authentication method as claimed in claim 15, wherein the predetermined information includes an address of a server that stores user identification information, the image forming apparatus sends user identification information input into the image forming apparatus to the server by using the address, and receives an authentication result from the server.

18. The authentication method as claimed in claim 17, wherein the server is a LDAP server.

19. The authentication method as claimed in claim 15, the authentication method further comprising a use restriction step for referring to predetermined information and performing use restriction by determining whether a user is permitted to use an application by using a method according to the predetermined information.

20. The authentication method as claimed in claim 19, wherein the image forming apparatus determines whether the user is permitted to use the application by using the method according to the predetermined information in the use restriction step when the image forming apparatus receives a process request from a client connected to the image forming apparatus via a network.

21. The authentication method as claimed in claim 15, the authentication method further comprising a billing step for referring to predetermined information and performing a billing process on the basis of usage of the application by the user by using a method according to the predetermined information.

22. The authentication method as claimed in claim 21, wherein the image forming apparatus performs the billing process by using the method according to the predetermined information in the billing step when the image forming apparatus receives a process request from a client connected to the image forming apparatus via a network.

23. The authentication method as claimed in claim 15, the authentication method further comprising a logging step for referring to predetermined information and storing a use history of the application in an apparatus according to the predetermined information.

24. The authentication method as claimed in claim 23, wherein the image forming apparatus stores the use history in the apparatus according to the predetermined information in the logging step when the image forming apparatus receives a process request from a client connected to the image forming apparatus via a network.

25. The authentication method as claimed in claim 15, the image forming apparatus includes an authentication control service that operates between the applications and the hardware resources, and the authentication step is performed by the authentication control service.

26. The authentication method as claimed in claim 25, the authentication method further comprising:
a XML conversion step of converting information obtained by the authentication control service into information of a XML format; and
a message sending step of generating a SOAP message from the information of the XML format and sending the SOAP message to a destination on a network on the basis of the SOAP protocol.

27. The authentication method as claimed in claim 26, wherein the image forming apparatus sends the SOAP message to a management apparatus on the network that manages a plurality of image forming apparatuses.

28. The authentication method as claimed in claim 26, the authentication method further comprising:
a message receiving step of receiving a SOAP request message from a client connected to a network, analyzing the SOAP request message and notifying the authentication control service of a process request.

29. A computer program for causing an image forming apparatus to perform an authentication process, the image forming apparatus including hardware resources used for image forming processes and applications for performing image forming processes, the computer program comprising:
authentication program code means for referring to predetermined information and performing authentication of a user who uses an application by using a method according to the predetermined information.

30. A computer readable recording medium storing computer program for causing an image forming apparatus to perform an authentication process, the image forming apparatus including hardware resources used for image forming processes and applications for performing image forming processes, the computer readable recording medium comprising:
authentication program code means for referring to predetermined information and performing authentication of a user who uses an application by using a method according to the predetermined information.

31. An information processing apparatus including hardware resources and applications for providing services by using the hardware resources, the information processing apparatus comprising:
an authentication part for referring to predetermined information and performing authentication of a user who uses an application by using a method according to the predetermined information.

32. The information processing apparatus as claimed in claim 31, wherein the authentication part performs authentication of the user by using the method when the authentication part receives a process request from a client connected to the information processing apparatus via a network.

33. The information processing apparatus as claimed in claim 31, wherein the predetermined information includes an address of a server that stores user identification information, the authentication part sends user identification information input into the information processing apparatus to the server by using the address, and receives an authentication result from the server.

34. The information processing apparatus as claimed in claim 33, wherein the server is a LDAP server.

35. The information processing apparatus as claimed in claim 31, the information processing apparatus further comprising a use restriction part for referring to predetermined information and performing use restriction by determining whether a user is permitted to use an application by using a method according to the predetermined information.

36. The information processing apparatus as claimed in claim 35, wherein the use restriction part determines whether the user is permitted to use the application by using the method when the use restriction part receives a process request from a client connected to the information processing apparatus via a network.

37. The information processing apparatus as claimed in claim 31, the information processing apparatus further comprising a billing part for referring to predetermined information and performing a billing process on the basis of usage of the application by the user by using a method according to the predetermined information.

38. The information processing apparatus as claimed in claim 37, wherein the billing part performs the billing process by using the method when the billing part receives a process request from a client connected to the information processing apparatus via a network.

39. The information processing apparatus as claimed in claim 31, the information processing apparatus further comprising a logging part for referring to predetermined information and storing a use history of the application in an apparatus according to the predetermined information.

40. The information processing apparatus as claimed in claim 39, wherein the logging part stores the use history in the apparatus when the logging part receives a process request from a client connected to the information processing apparatus via a network.

41. The information processing apparatus as claimed in claim 31, the information processing apparatus includes an authentication control service that operates between the applications and the hardware resources, and the authentication control service includes the authentication part.

42. The information processing apparatus as claimed in claim 41, the information processing apparatus further comprising:
a XML conversion part for converting information obtained by the authentication control service into information of a XML format; and
a message sending part for generating a SOAP message from the information of the XML format and sending the SOAP message to a destination on a network on the basis of the SOAP protocol.

43. The information processing apparatus as claimed in claim 42, wherein the message sending part sends the SOAP message to a management apparatus on the network that manages a plurality of information processing apparatuses.

44. The information processing apparatus as claimed in claim 42, the information processing apparatus further comprising:
a message receiving part for receiving a SOAP request message from a client connected to a network, analyzing the SOAP request message and notifying the authentication control service of a process request.

45. An authentication method used in an information processing apparatus including hardware resources and applications for providing services by using the hardware resources, the authentication method comprising:
an authentication step of referring to predetermined information and performing authentication of a user who uses an application by using a method according to the predetermined information.

46. The authentication method as claimed in claim 45, wherein the information processing apparatus performs authentication of the user by using the method according to the predetermined information in the authentication step when the information processing apparatus receives a process request from a client connected to the information processing apparatus via a network.

47. The authentication method as claimed in claim 45, wherein the predetermined information includes an address of a server that stores user identification information, the information processing apparatus sends user identification information input into the information processing apparatus to the server by using the address, and receives an authentication result from the server.

48. The authentication method as claimed in claim 47, wherein the server is a LDAP server.

49. The authentication method as claimed in claim 45, the authentication method further comprising a use restriction step for referring to predetermined information and performing use restriction by determining whether a user is permitted to use an application by using a method according to the predetermined information.

50. The authentication method as claimed in claim 49, wherein the information processing apparatus determines whether the user is permitted to use the application by using the method according to the predetermined information in the use restriction step when the information processing apparatus receives a process request from a client connected to the information processing apparatus via a network.

51. The authentication method as claimed in claim 45, the authentication method further comprising a billing step for referring to predetermined information and performing a billing process on the basis of usage of the application by the user by using a method according to the predetermined information.

52. The authentication method as claimed in claim 51, wherein the information processing apparatus performs the billing process by using the method according to the predetermined information in the billing step when the information processing apparatus receives a process request from a client connected to the information processing apparatus via a network.

53. The authentication method as claimed in claim 45, the authentication method further comprising a logging step for referring to predetermined information and storing a use history of the application in an apparatus according to the predetermined information.

54. The authentication method as claimed in claim 53, wherein the information processing apparatus stores the use history in the apparatus according to the predetermined information in the logging step when the information processing apparatus receives a process request from a client connected to the information processing apparatus via a network.

55. The authentication method as claimed in claim 45, the information processing apparatus includes an authentication control service that operates between the applications and the hardware resources, and the authentication step is performed by the authentication control service.

56. The authentication method as claimed in claim 55, the authentication method further comprising:
a XML conversion step of converting information obtained by the authentication control service into information of a XML format; and
a message sending step of generating a SOAP message from the information of the XML format and sending the SOAP message to a destination on a network on the basis of the SOAP protocol.

57. The authentication method as claimed in claim 56, wherein the information processing apparatus sends the SOAP message to a management apparatus on the network that manages a plurality of information processing apparatuses.

58. The authentication method as claimed in claim 56, the authentication method further comprising:
a message receiving step of receiving a SOAP request message from a client connected to a network, analyzing the SOAP request message and notifying the authentication control service of a process request.

59. A computer program for causing an information processing apparatus to perform an authentication process, the information processing apparatus including hardware resources and applications for providing services by using the hardware resources, the computer program comprising:
authentication program code means for referring to predetermined information and performing authentication of a user who uses an application by using a method according to the predetermined information.

60. A computer readable recording medium storing computer program for causing an information processing apparatus to perform an authentication process, the information processing apparatus including hardware resources and applications for providing services by using the hardware resources, the computer readable recording medium comprising:
authentication program code means for referring to predetermined information and performing authentication of a user who uses an application by using a method according to the predetermined information.
